(19) United States
(12) Patent Application Publication
(10) Pub. No.: US 2025/0028492 A1
(43) Pub. Date: Jan. 23, 2025

(54) INFORMATION PROCESSING APPARATUS INCLUDING ROTATABLE DISPLAY DEVICE, AND IMAGE FORMING APPARATUS

(71) Applicant: KYOCERA Document Solutions Inc., Osaka (JP)

(72) Inventor: Kenji TAKAI, Osaka (JP)

(73) Assignee: KYOCERA Document Solutions Inc., Osaka (JP)

(21) Appl. No.: 18/766,664

(22) Filed: Jul. 9, 2024

(30) Foreign Application Priority Data
Jul. 19, 2023 (JP) 2023-117895

(51) Int. Cl. G06F 3/14; G06F 3/0346

(52) U.S. Cl. CPC G06F 3/14; G06F 3/0346

(57) ABSTRACT

An image forming apparatus includes a display device, a rotation mechanism that allows the display device to rotate between a landscape orientation in which the long sides are a top and a bottom and a portrait orientation in which the short sides are a top and a bottom, a detection sensor that detects switching between the landscape orientation and the portrait orientation of the display device, and a controller that causes the display device to perform display according to a posture of the display device based on a detection result obtained by the detection sensor. Further, when the controller determines that the posture of the display device has switched at a predetermined frequency or more based on the detection result obtained by the detection sensor, the controller causes the display device to display a message indicating occurrence of a problem related to a rotational operation of the display device.

### INCORPORATION BY REFERENCE

This application claims priority to Japanese Patent Application No. 2023-117895 filed on Jul. 19, 2023, the entire contents of which are incorporated by reference herein.

### BACKGROUND

The disclosure relates to an information processing apparatus and an image forming apparatus.

Some information processing apparatuses such as image forming apparatuses include a rectangular display device having long sides and short sides, and a display screen thereof can be rotated vertically or horizontally. For example, image forming apparatuses have been proposed which include a rectangular display device having long sides and short sides and a rotation mechanism rotating the display device between a landscape orientation in which the long sides are the top and bottom, and a portrait orientation in which the short sides are the top and bottom.

### SUMMARY

As one aspect of the disclosure, technology obtained by further improving the above-described technology is proposed.

An information processing apparatus according to one aspect of the disclosure includes a display device, a rotation mechanism, a detection sensor, and a control device. The display device has a rectangular shape having long sides and short sides. The rotation mechanism allows the display device to rotate between a landscape orientation in which the long sides are a top and a bottom and a portrait orientation in which the short sides are a top and a bottom. The detection sensor detects whether the display device is in a landscape-oriented state or a portrait oriented state. The control device includes a processor and causes the processor to execute a control program to function as a controller. The control device causes the display device to perform display according to a posture in the landscape-oriented state or the portrait oriented state of the display device based on a detection result obtained by the detection sensor. Further, when the controller determines that the posture of the display device has switched between the landscape-oriented state and the portrait oriented state at a predetermined frequency or more based on the detection result obtained by the detection sensor, the controller causes the display device to display a message indicating occurrence of a problem related to a rotational operation of the display device.

An image forming apparatus according to an aspect of the disclosure includes an information processing apparatus according to an aspect of the disclosure and an image forming device. The image forming device forms an image on a recording medium.

### BRIEF DESCRIPTION OF THE DRAWINGS

FIG. 1 is a front cross-sectional view showing the structure of an image forming apparatus according to an embodiment of the disclosure.

FIG. 2 is a functional block diagram schematically showing a main internal configuration of the image forming apparatus according to the embodiment of the disclosure.

FIGS. 3A to 3G are diagrams showing examples of rotation of a display device.

FIGS. 4A and 4B are diagrams illustrating changes in signals output from a detection sensor.

FIGS. 5 to 7 are diagrams showing examples of operation screens displayed on the display device.

FIG. 8 is a flowchart showing an example of error display processing accompanying changes in the posture of the display device which is performed by a controller.

FIGS. 9A and 9B are diagrams showing examples of operation screens displayed on the display device.

### DETAILED DESCRIPTION

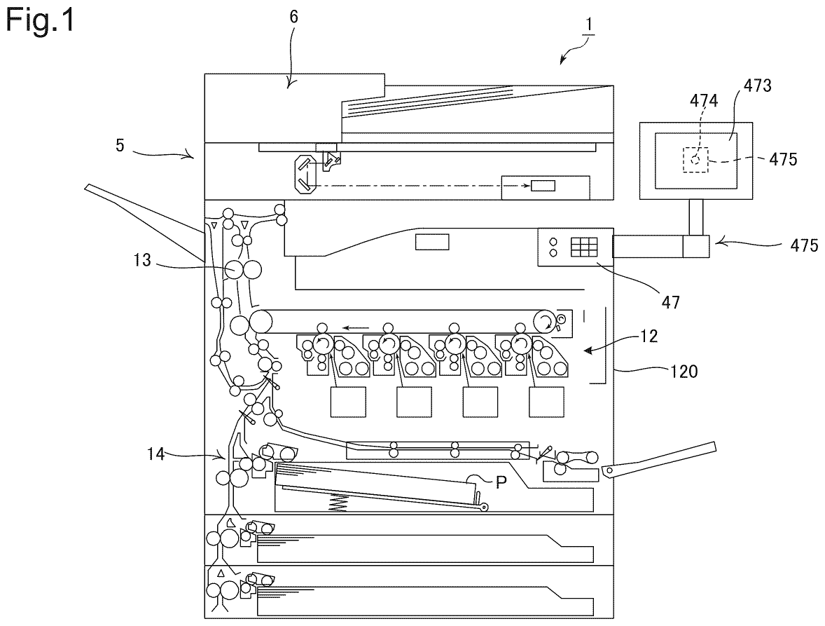

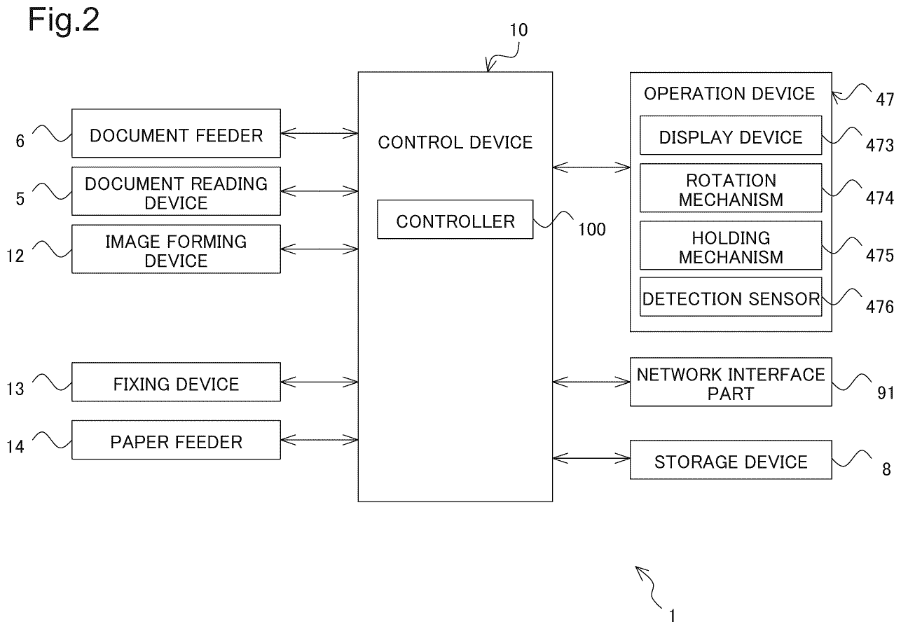

Hereinafter, an information processing apparatus according to an embodiment of the disclosure will be described with reference to the drawings. The information processing apparatus according to the embodiment of the disclosure is, for example, an image forming apparatus. FIG. 1 is a front cross-sectional view showing the structure of an image forming apparatus according to the embodiment of the disclosure. FIG. 2 is a functional block diagram schematically showing a main internal configuration of the image forming apparatus according to the embodiment of the disclosure. In the following, left, right, upward, and downward directions may be indicated, but these are directions as an example in each drawing unless otherwise specified.

An image forming apparatus 1 is a multifunction device that has a plurality of functions such as a copy function, a printer function, a scanner function, and a facsimile function. The image forming apparatus 1 is configured to include a control device 10, a document feeder 6, a document reading device 5, an image forming device 12, a fixing device 13, a paper feeder 14, an operation device 47, a network interface device 91, and a storage device 8.

The document feeder 6 is configured to be openable and closable by a hinge or the like (not shown) on the upper surface of the document reading device 5. The document feeder 6 functions as a document holding cover when the document reading device 5 reads a document placed on a platen glass (not shown). Further, the document feeder 6 is an auto document feeder (ADF), includes a document placement tray (not shown), and supplies the document placed on the document placement tray to the document reading device 5.

The document reading device 5 includes a scanner and the like, and reads a document fed from the document feeder 6 or reads a document placed on the platen glass.

A case where the image forming apparatus 1 performs a document reading operation will be described. The document reading device 5 optically reads an image of a document supplied to the document reading device 5 by the document feeder 6 or placed on the platen glass, and generates image data. The image data generated by the document reading device 5 is stored in an image memory (not shown) or the like.

A case where an image forming operation is performed by the image forming apparatus 1 will be described. The image forming device 12 is a mechanism that includes a photosensitive drum, a charging device, an exposure device, a developing device, and a primary transfer device for each color and forms an image on recording paper by secondary transfer via an intermediate transfer belt. The image forming device 12 forms a toner image on recording paper as a recording medium fed from the paper feeder 14 to create printed matter based on image data generated through a document reading operation, image data stored in the image memory, or the like, image data received from a computer connected to a network, or the like. The paper feeder 14 includes a paper feeding cassette, and further includes a pickup roller that picks up recording paper from the paper feeding cassette and feeds it to the image forming device 12, a transport roller, a transport path, and a rotation drive mechanism for each roller.

The fixing device 13 is a fixing device that includes a heat roller, a pressure roller, and a drive mechanism that rotationally drives these rollers, and heats and presses recording paper on which a toner image has been formed by the image forming device 12 with a nip between the two rollers to fix the toner image on the recording paper, and the recording paper that has been subjected to the fixing processing is discharged to a discharge tray (not shown).

The operation device 47 includes various hard keys operated by a user, and receives instructions from the user, such as an instruction to execute an image forming operation, regarding various operations and processes that can be executed by the image forming apparatus 1 in accordance with operations of the hard keys.

The operation device 47 includes a display device 473 that displays operation guidance for an operator, and the like, a rotation mechanism 474, a holding mechanism 475, and a detection sensor 476. Further, the operation device 47 receives an input of an instruction from the user via a touch panel included in the display device 473 based on the user's operation (touch operation) on a screen displayed on the display device 473.

The display device 473 is a rectangular display having long sides and short sides and is constituted by a liquid crystal display (LCD) or the like. When the operator performs an operation of touching a button or a key displayed on the screen, the touch panel receives an instruction associated with the position of the touch operation. In this case, the touch panel functions as an operation device.

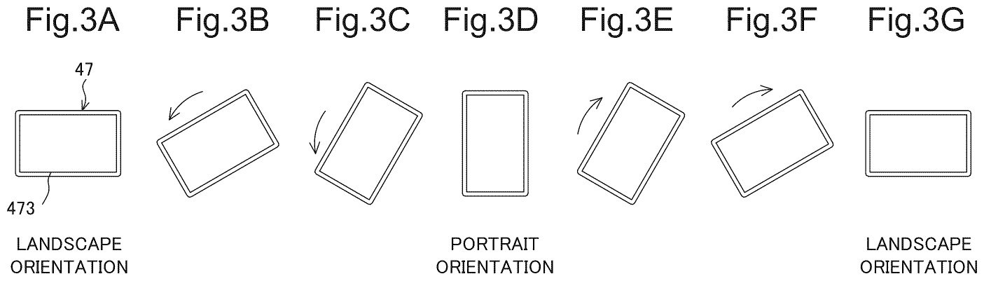

The holding mechanism 475 is an arm-shaped member that attaches the display device 473 to an apparatus main body 120 of the image forming apparatus 1. The holding mechanism 475 rotatably supports the display device 473 with respect to the holding mechanism 475, and temporarily fixes and holds the display device 473 in each of horizontal and vertical postures. The holding mechanism 475 includes engaging parts, constituted by concave parts provided at positions facing the display device 473, at positions corresponding to the horizontal and vertical posture positions of the display device 473, respectively. A convex part that fits to the engaging part is provided on the side surface of the display device 473 facing the holding mechanism 475. When the display device 473 is placed in the horizontal posture (FIGS. 3A and 3G) or the vertical posture (FIG. 3D), these concave parts and convex parts fit together, and thus the posture of the display device 473 is fixed and held.

The rotation mechanism 474 is interposed between the holding mechanism 475 and the display device 473. That is, the holding mechanism 475 rotatably supports the display device 473 via the rotation mechanism 474. The rotation mechanism 474 includes a rotating shaft, and the rotating shaft is rotatably supported by the holding mechanism 475. The rotating shaft is attached to a rectangular central part on the side surface of the display device 473 facing the holding mechanism 475 so as to rotate together with the display device 473. A cam (described later) that rotates together with the rotating shaft is provided on the circumferential surface of the rotating shaft.

FIGS. 3A to 3G are diagrams showing examples of rotation of the display device 473. The landscape-oriented state display device 473 shown in FIG. 3A is rotated counterclockwise and portrait oriented in FIG. 3, as shown in FIGS. 3B to 3D. Further, the portrait oriented display device 473 shown in FIG. 3D is rotated clockwise and landscape-oriented state, as shown in FIGS. 3E to 3G.

That is, the rotation mechanism 474 is configured to switch the display device 473 from the landscape orientation to the portrait orientation by rotating the display device 473 counterclockwise in FIG. 3 when viewed from the surface of the display device 473. The range of a rotation angle of the display device 473 is not limited to 90 degrees, but here, a case where the range of the rotation angle is 90 degrees is taken as an example. However, the rotation direction of the display device 473 and a configuration for switching the display device 473 from the landscape orientation to the portrait orientation are not limited thereto, and this embodiment is merely an example.

The detection sensor 476 is a switch mechanism that detects the horizontal posture and vertical posture of the display device 473. The switch mechanism is provided at a position where it is pressed by a cam lobe (convex part) of the cam attached to the rotating shaft when the display device 473 is in the vertical posture. The switch mechanism outputs an ON signal (Low signal) to the control device 10 when pressed by the cam lobe. That is, the switch mechanism is disposed at a position where it is not pressed by the cam lobe when the display device 473 is in a posture other than the vertical posture.

As the above-described configuration of the rotation mechanism 474 that switches the display device 473 from the landscape orientation to the portrait orientation by rotating the display device 473 counterclockwise in FIG. 3 when viewed from the surface of the display device 473, for example, a configuration is adopted in which the cam lobe can enter the switch mechanism only when the display device 473 is rotated counterclockwise, and the cam lobe cannot enter the switch mechanism when the display device 473 is rotated clockwise (a convex part engaging the cam lobe is provided at an outer edge of the switch mechanism in an approach path to the switch mechanism for the cam lobe from the clockwise direction, or the like).

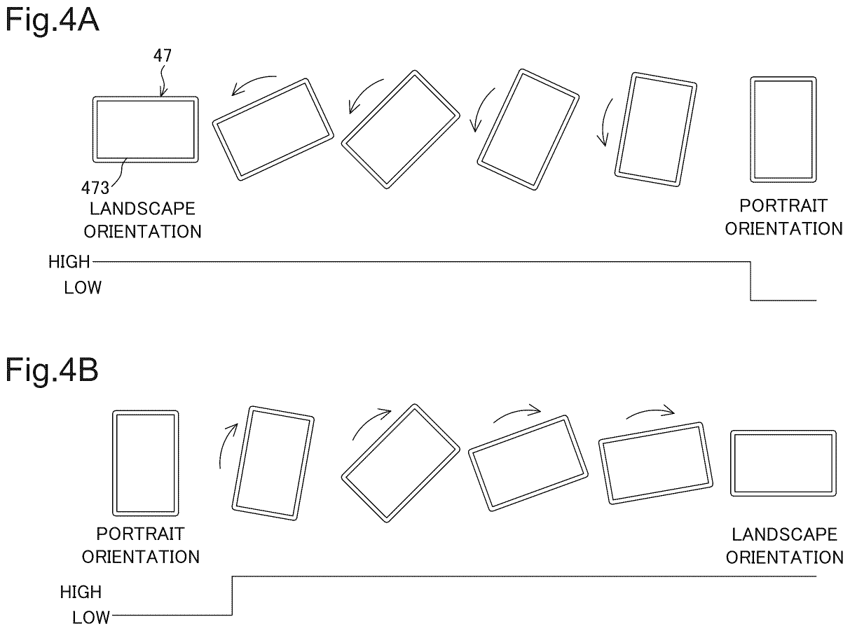

FIGS. 4A and 4B are diagrams showing changes in signals output from the detection sensor 476 provided at a position corresponding to the vertical posture of the display device 473. As shown in FIGS. 4A and 4B, the detection sensor 476 provided at a position corresponding to the vertical posture of the display device 473 outputs a Low signal to the control device 10 when the display device 473 is in the vertical posture (when the switch mechanism is pressed by the cam lobe), and outputs a High signal to the control device 10 in the other cases (when the switch mechanism is not pressed by the cam lobe).

Thus, the detection sensor 476 outputs a Low signal to the control device 10 when the display device 473 is in the portrait oriented posture shown in FIG. 3D, but outputs a High signal to the control device 10 when the display device 473 is in a posture other than the portrait oriented posture shown in FIG. 3D. Thereby, a controller 100, which will be described later, determines whether the display device 473 is in a portrait oriented posture or in a posture other than the portrait oriented posture based on a signal output from the detection sensor 476. Specifically, the controller 100 determines that the display device 473 is portrait oriented when the display device 473 is in the portrait oriented posture shown in FIG. 3D, and determines that the display device 473 is landscape-oriented state when the display device 473 is in all other postures.

The network interface device 91 is a communication interface that transmits and receives various data to and from an external device (for example, a personal computer) within a local area or on the Internet.

The storage device 8 is a large capacity storage device such as a hard disk drive (HDD) or a solid state drive (SSD), and stores various control programs and the like.

The control device 10 is configured to include a processor, a random access memory (RAM), a read only memory (ROM), and a dedicated hardware circuit. The processor is, for example, a central processing unit (CPU), an application specific integrated circuit (ASIC), or a micro processing unit (MPU). The control device 10 includes the controller 100.

The control device 10 functions as the controller 100 in accordance with an operation of the processor according to the control program stored in the storage device 8. However, the controller 100 can also be constituted by a hardware circuit regardless of an operation of the control device 10 according to a control program. The same applies to each embodiment below unless otherwise mentioned.

The controller 100 controls the overall operation of the image forming apparatus 1. The controller 100 is connected to the document feeder 6, the document reading device 5, the image forming device 12, the fixing device 13, the paper feeder 14, the operation device 47, the network interface device 91, and the storage device 8, and controls the driving of each of these parts. For example, the controller 100 executes various processes necessary for image formation of the image forming apparatus 1.

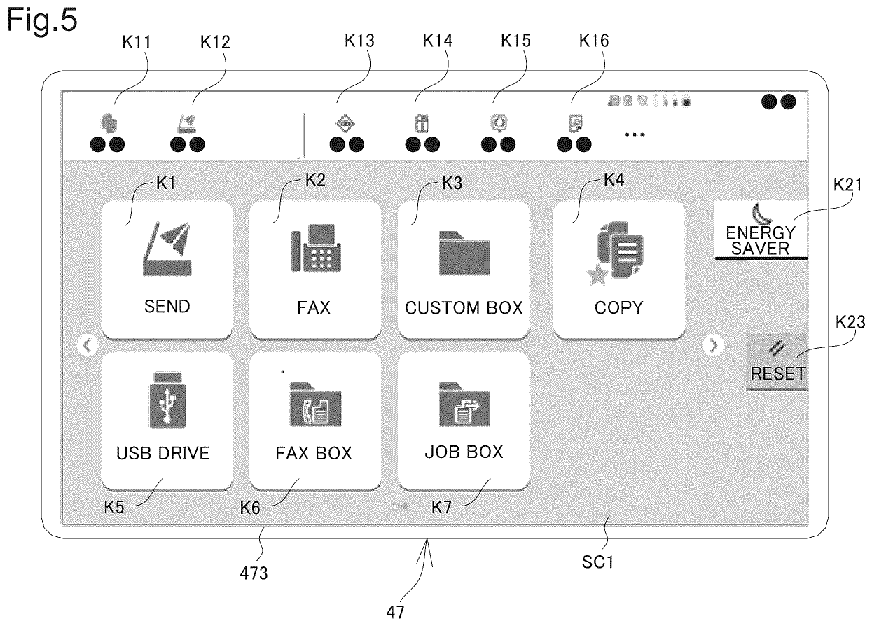

In addition, the controller 100 controls the display of the display device 473. For example, the controller 100 causes the display device 473 to display an operation screen SC1 as illustrated in FIG. 5 as a “home screen”. On the operation screen SC1, operation keys K1 to K7 referred to as “application icons” or the like are disposed. For example, the operation key K4 is an icon in which a character string “Copy” is written and a picture of “Copy” is expressed. Further, on the operation screen SC1, operation keys K11 to K16 referred to as “task icons” or the like are disposed at an upper end, and operation keys K21 and K23 are disposed at a right end.

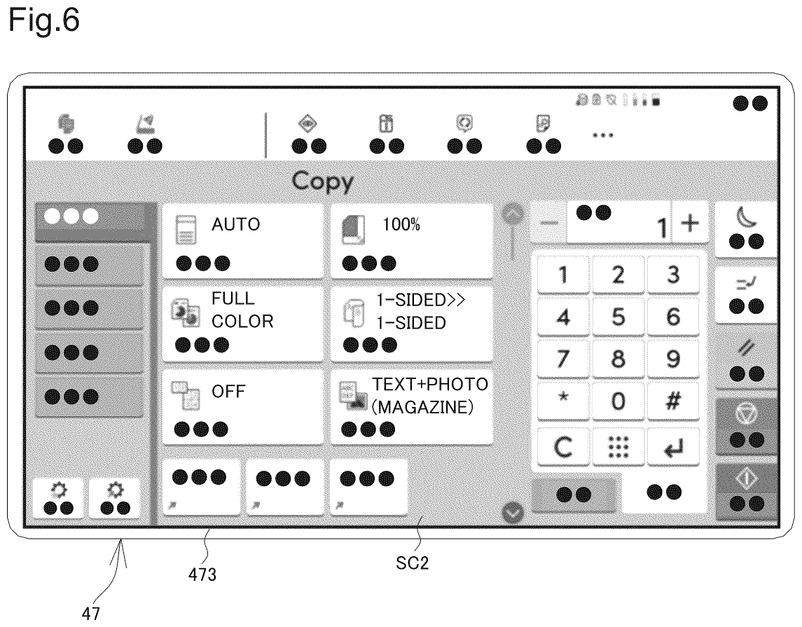

The controller 100 performs control based on instructions received by the operation device 47. For example, when the operation device 47 receives an instruction for the operation key K4 via the touch panel, the controller 100 controls the display of the display device 473 in response to the instruction, and changes the operation screen displayed on the display device 473 from the “home screen” to a “copy screen” as illustrated in FIG. 6.

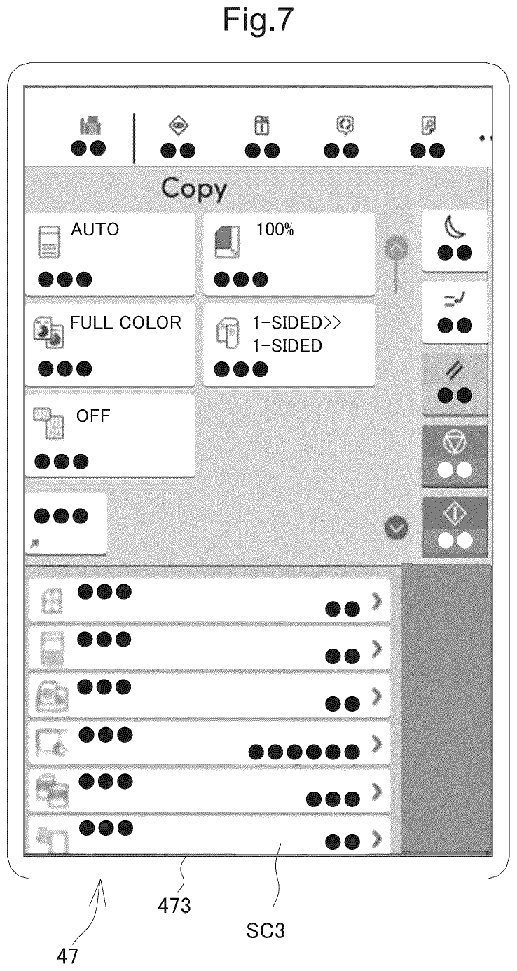

Based on a detection result obtained by the detection sensor 476, the controller 100 performs display according to the posture of the display device 473 on the display device 473. Specifically, the controller 100 controls the display device 473 based on a detection signal output from the detection sensor 476, and causes the display device 473 to display a screen according to the posture of the display device 473. For example, when an operation screen SC2 shown in FIG. 6 is displayed on the display device 473, and the detection sensor 476 detects switching from the landscape orientation to the portrait orientation of the display device 473, the controller 100 changes a screen displayed on the display device 473 from the operation screen SC2 (FIG. 6) to an operation screen SC3 as illustrated in FIG. 7.

In contrast, when the detection sensor 476 detects that the display device 473 is switched from the portrait orientation to the landscape orientation while the operation screen SC3 shown in FIG. 7 is displayed on the display device 473, the controller 100 changes the screen displayed on the display device 473 from the operation screen SC3 (FIG. 7) to the operation screen SC2 (FIG. 6).

In addition, when the controller 100 determines that the vertical and landscape orientations of the display device 473 have been switched between at a predetermined frequency F or more based on the detection result obtained by the detection sensor 476, the controller 100 displays a message indicating the occurrence of a problem related to a rotational operation of the display device 473 on the display device 473. Specifically, when the controller 100 detects switching of postures a predetermined number of times C1 or more within a predetermined time T1 (for example, when switching of postures 5 times or more per second is detected) from the time when the detection sensor 476 detects switching from the portrait oriented or landscape-oriented state posture of the display device 473 to the other posture, the controller 100 determines that the posture of the display device 473 has been switched at a predetermined frequency F or more.

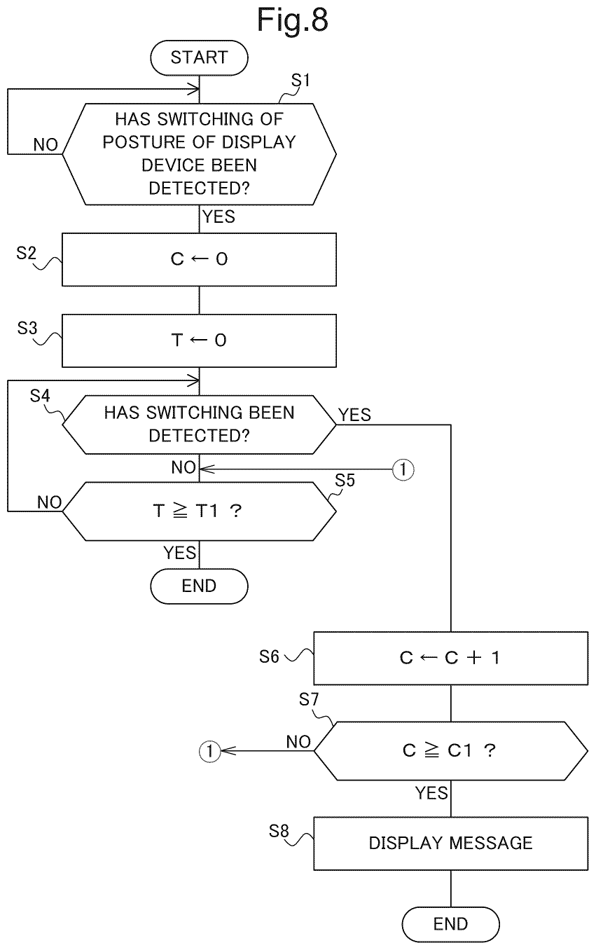

Next, an example of error display processing accompanying changes in the posture of the display device 473 which is performed by the controller 100 will be described using a flowchart shown in FIG. 8.

The controller 100 determines whether the detection sensor 476 has detected switching of the posture of the display device 473 (S1). That is, the controller 100 determines whether a signal output from the detection sensor 476 to the control device 10 has been switched from a High signal to a Low signal, or from a Low signal to a High signal.

When the controller 100 determines that the detection sensor 476 has detected switching of the posture of the display device 473 (YES in S1), the controller 100 resets a counter C for counting the switching of the posture of the display device 473 to 0 (S2), resets a timer T built in the control device 10 to 0, and starts measuring a time using the timer T (S3).

Based on a detection signal output from the detection sensor 476, the controller 100 determines whether the detection sensor 476 has detected new switching of the posture of the display device 473 (S4). When the controller 100 determines that the detection sensor 476 has detected new switching of the posture of the display device 473 (YES in S4), the controller 100 adds 1 to the counter C (S6) and determines whether the counter C has reached the number of times C1 or more (S7).

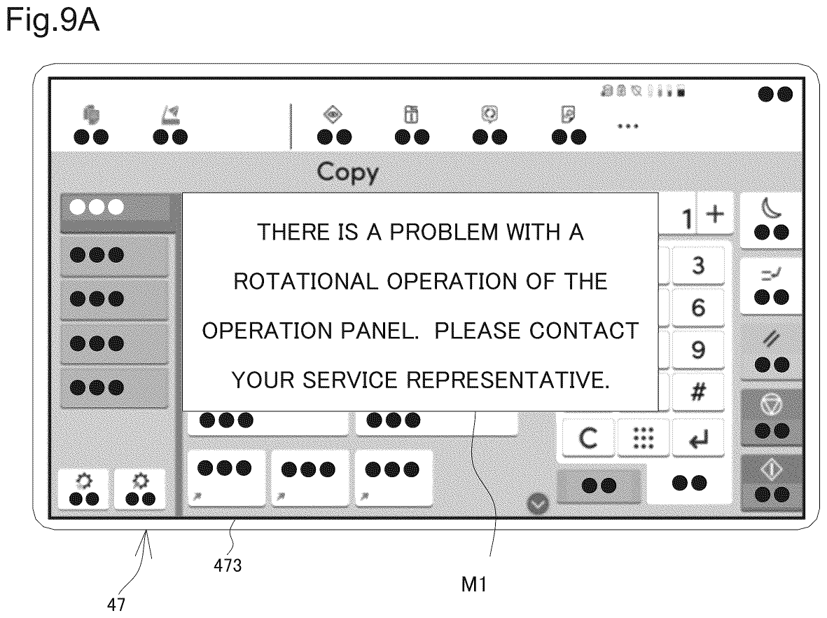

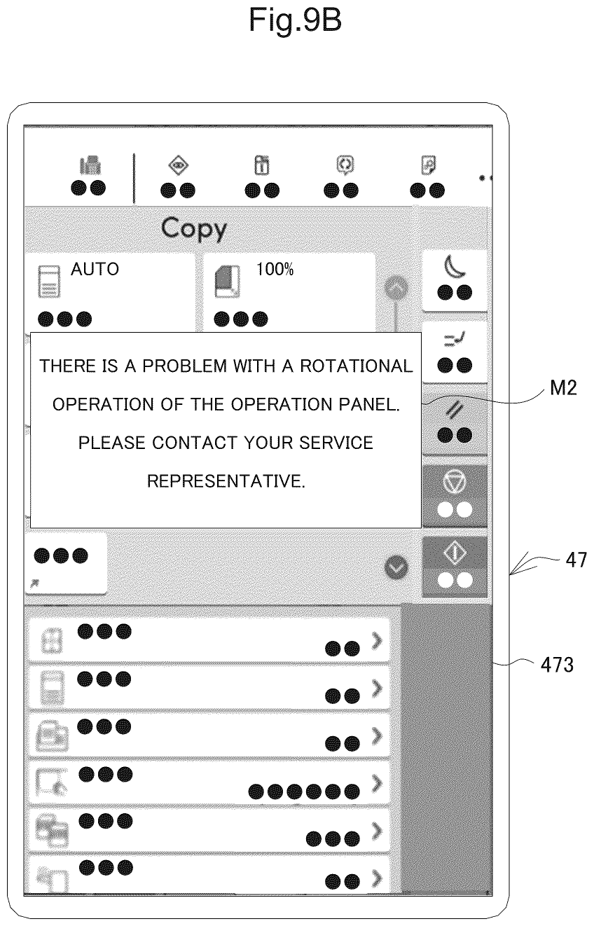

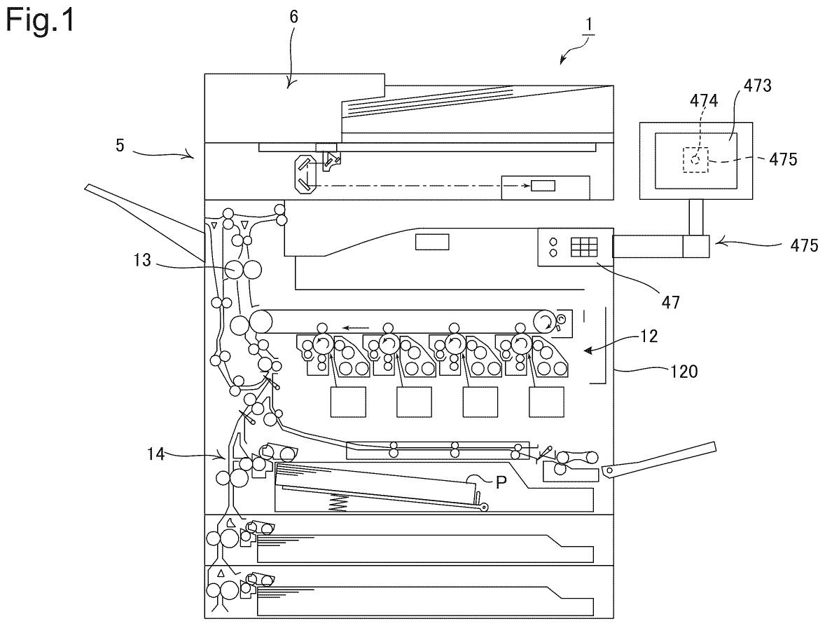

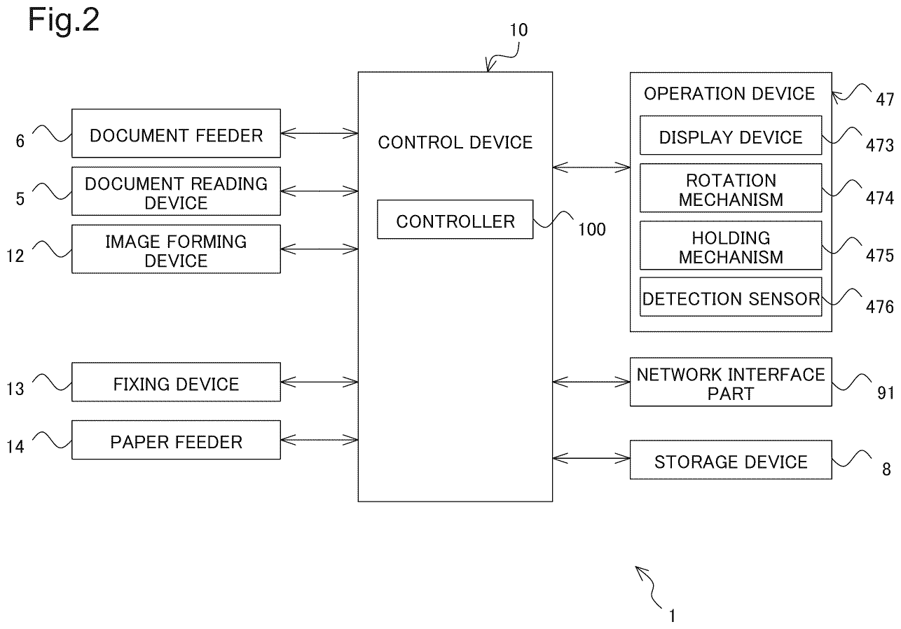

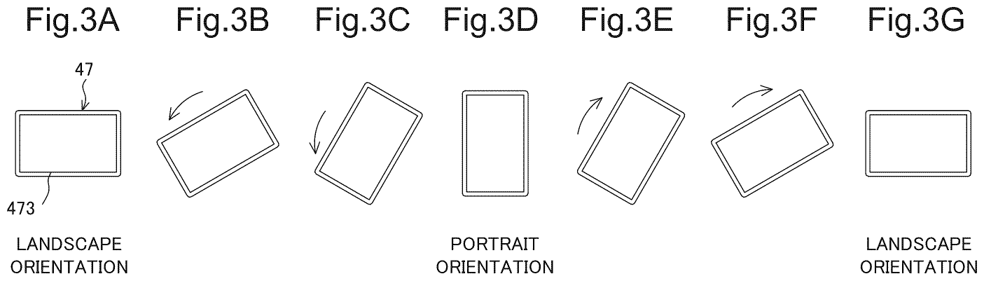

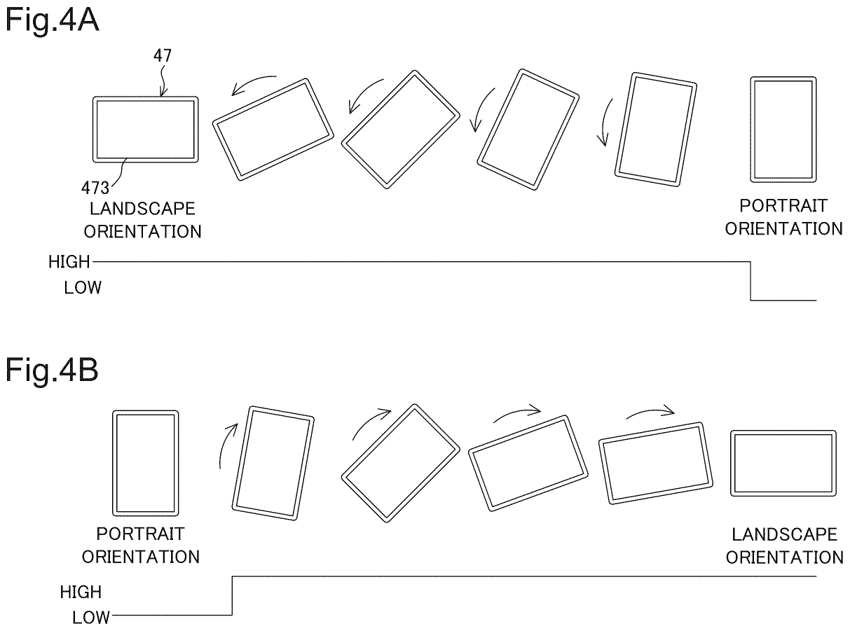

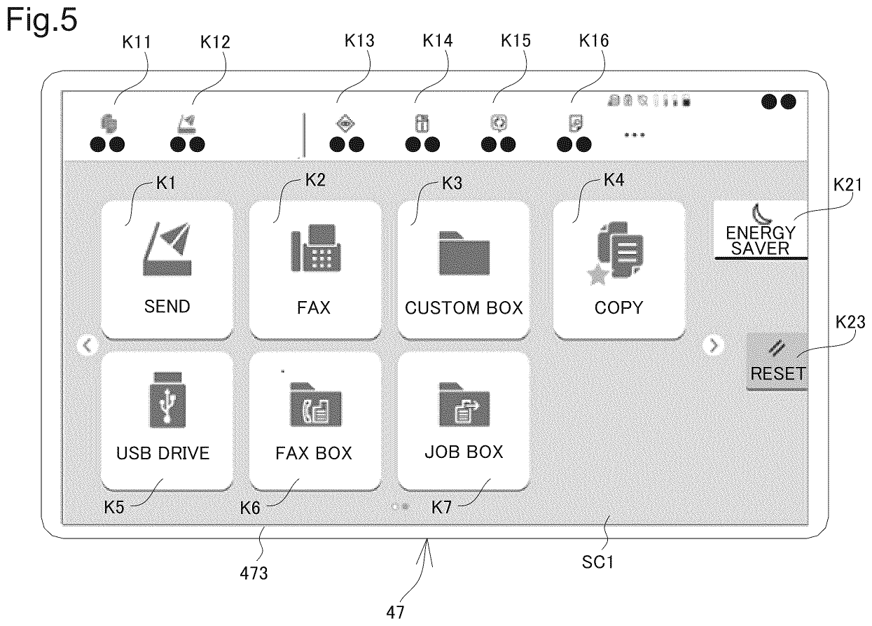

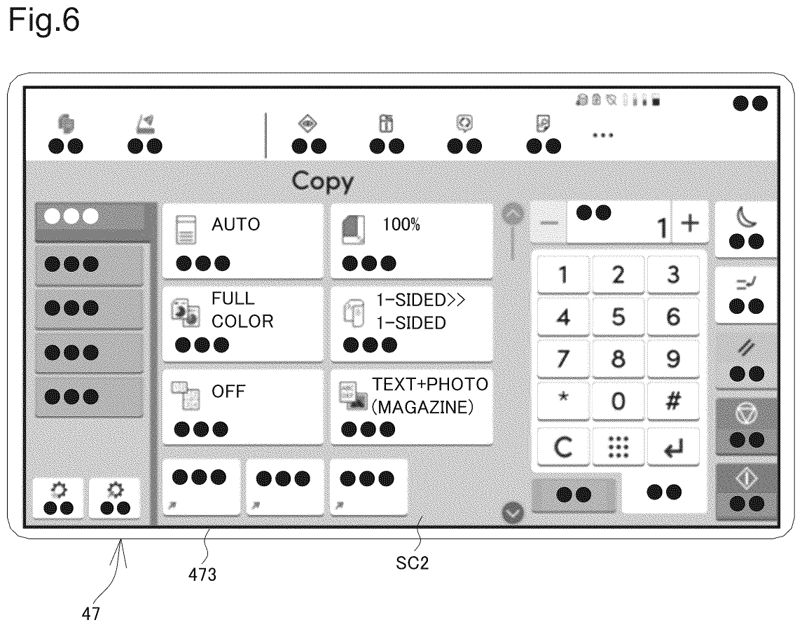

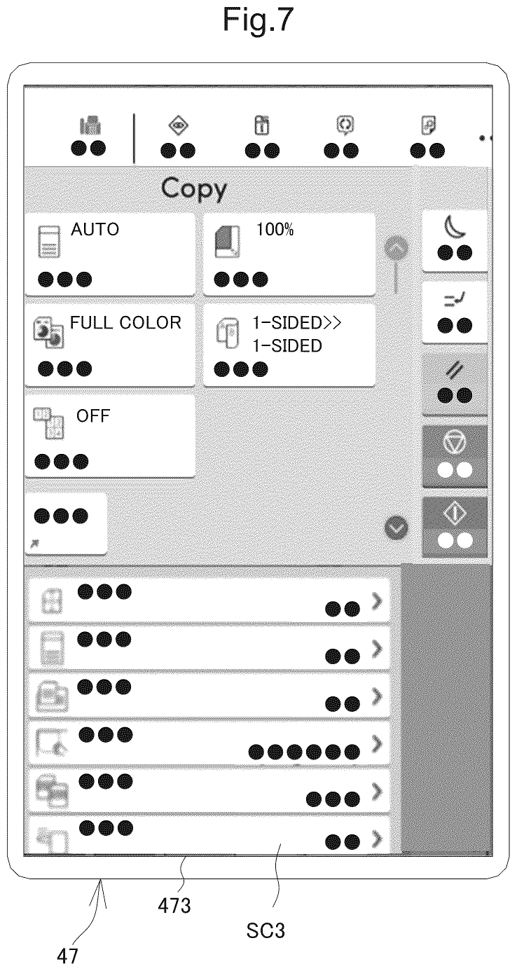

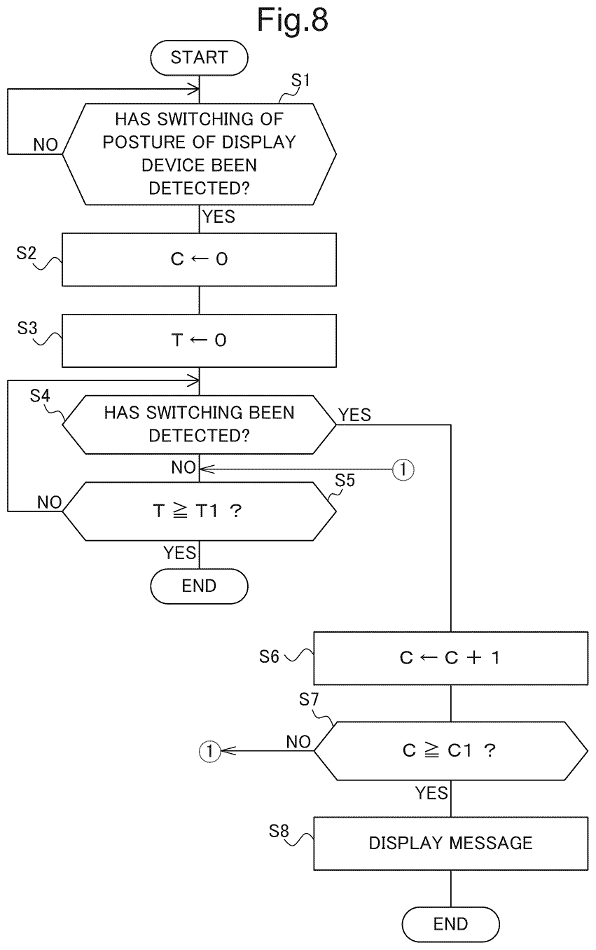

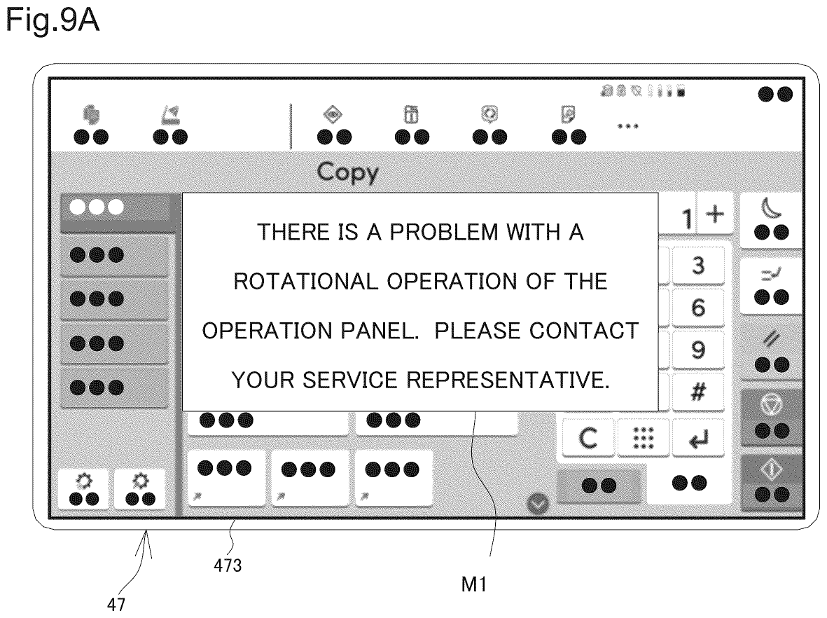

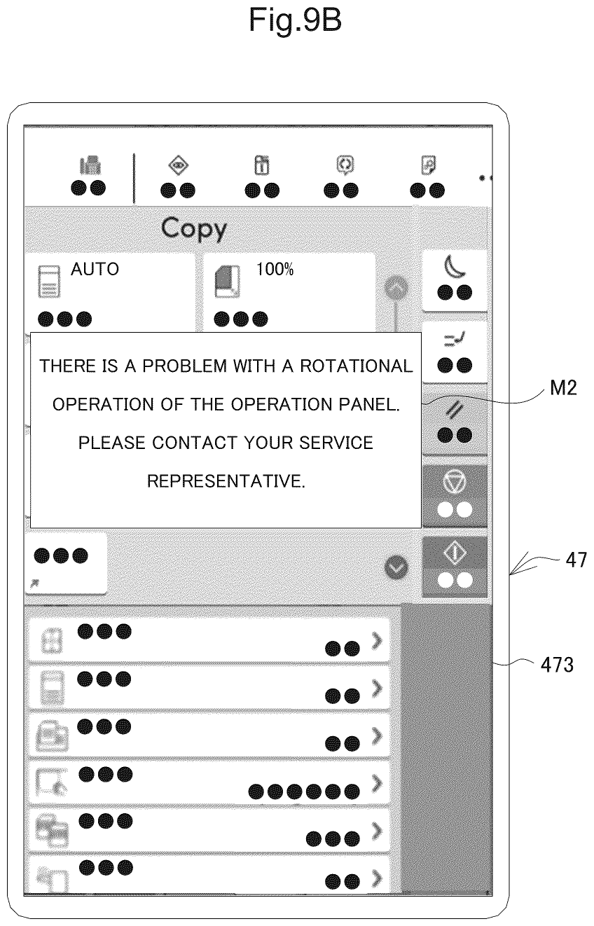

When the controller 100 determines that the counter C has reached the number of times C1 or more (YES in S7), the controller 100 displays messages M1 and M2, for example, “There is a problem with a rotational operation of the operation panel. Please contact your service representative.” indicating the occurrence of a problem related to the rotational operation of the display device 473 on the display device 473 in a display mode corresponding to the orientation of the display device 473 at that point in time based on the detection signal output from the detection sensor 476 as shown in FIGS. 9A and 9B (S8). Thereafter, the processing ends.

On the other hand, when the controller 100 determines that the counter C has not reached the number of times C1 or more (NO in S7), the processing proceeds to S5.

When the controller 100 determines that the counter C has not reached the number of times C1 or more (NO in S7), and when the controller 100 determines in S4 that the detection sensor 476 has not detected new switching of the posture of the display device 473 (NO in S4), the controller 100 determines whether the time of the timer T has elapsed by a time T1 (S5).

Here, when the controller 100 determines that the time of the timer T has passed by the time T1 (YES in S5), the processing ends. On the other hand, when the controller 100 determines that the time of the timer T has not elapsed by the time T1 (NO in S5), the processing returns to S4.

According to the embodiment described above, when the posture of the display device 473 switches frequently, the messages M1 and M2 indicating the occurrence of a problem related to the rotational operation of the display device 473 are displayed on the display device 473.

In normal use, the posture of the display device 473 rarely switches frequently. That is, when the posture of the display device 473 switches frequently, there is a high possibility that a problem will occur in the rotational operation of the display device 473. For example, a problem due to deterioration of the holding mechanism 475 may be the cause. There are cases where fitting of the above-described concave parts and convex parts becomes loose, and the display device 473 is not stably held in a portrait oriented posture. For this reason, when the posture of the display device 473 switches frequently (when there is a high possibility that a problem occurs in the rotational operation of the display device 473), the messages M1 and M2 are displayed on the display device 473, thereby allowing the user to recognize that a problem has occurred in the rotational operation of the display device 473.

In S8, the controller 100 causes the display device 473 to display the message M1 or M2 in a display mode corresponding to the posture of the display device 473 based on the detection signal output from the detection sensor 476. However, alternatively, when the message M1 or M2 is displayed in S8, the controller 100 may cause the display device 473 to display the message M1 or M2 in a display mode corresponding to one predetermined posture in a landscape-oriented state or a portrait oriented state, regardless of a detection result indicated by the detection signal output from the detection sensor 476. In a case where the message M1 or M2 is displayed on the display device 473 in a display mode corresponding to the orientation of the display device 473 when a problem occurs in the rotational operation of the display device 473, the orientation of an image displayed on the display device 473 frequently switches to landscape orientation or portrait orientation in accordance with slight rotation of the display device 473, and it becomes difficult for the user to visually recognize the message. Thus, in order to improve the visibility of the message for the user, the message M1 or M2 is displayed on the display device 473 in a fixed display mode corresponding to one predetermined posture.

The information processing apparatus according to the embodiment of the disclosure is, for example, a personal computer or the like, and includes at least the operation device 47, the display device 473, the rotation mechanism 474, the detection sensor 476, and the controller 100. In the information processing apparatus according to the embodiment of the disclosure, the image forming device 12 is not an essential component. In the information processing apparatus according to the embodiment of the disclosure, even when the controller 100 causes the display device 473 to display image data stored in, for example, a built-in memory or an HDD, the controller 100 performs display control accompanying changes in the posture of the display device 473 by the controller 100 described above. In this case, the above-described processing related to image formation is naturally not performed.

Further, in the image forming apparatus 1, the storage device 8 includes a document box as its storage area, and when image data to be displayed on the display device 473 is stored in the document box, the controller 100 also performs display control accompanying changes in the posture of the display device 473 by the controller 100 described above when the image data is displayed on the display device 473.

The disclosure is not limited to the configuration of the above-described embodiment, and various modifications can be made. Further, in the above-described embodiment, the configuration and processing shown in the embodiment using FIGS. 1 to 9 are only one embodiment of the disclosure, and the disclosure is not intended to be limited to the configuration and processing.

While the disclosure has been described in detail with reference to the embodiments thereof, it would be apparent to those skilled in the art that the various changes and modifications may be made therein within the scope defined by the appended claims.

What is claimed is:

1. An information processing apparatus comprising:
a display device that has a rectangular shape and has long sides and short sides;
a rotation mechanism that allows the display device to rotate between a landscape orientation in which the long sides are a top and a bottom and a portrait orientation in which the short sides are a top and a bottom;
a detection sensor that detects whether the display device is in a landscape-oriented state or a portrait oriented state; and
a control device that includes a processor and causes the processor to execute a control program to function as a controller that causes the display device to perform display according to a posture in the landscape-oriented state or the portrait oriented state of the display device based on a detection result obtained by the detection sensor, wherein
when the controller determines that the posture of the display device has switched between the landscape-oriented state and the portrait oriented state at a predetermined frequency or more based on the detection result obtained by the detection sensor, the controller causes the display device to display a message indicating occurrence of a problem related to a rotational operation of the display device.

2. The information processing apparatus according to claim 1, wherein
when the detection sensor detects the switching of the posture of the display device and then detects that the posture has switched a predetermined number of times or more within a predetermined time, the controller determines that the posture of the display device has switched at the predetermined frequency or more.

3. The information processing apparatus according to claim 1, wherein
when the message is displayed on the display device, the controller displays the message in a display mode corresponding to the orientation of the display device which is indicated by the detection result obtained by the detection sensor.

4. The information processing apparatus according to claim 1, wherein
when the message is displayed on the display device, the controller causes the display device to display the message in a display mode corresponding to a predetermined one posture in the landscape-oriented state or the portrait oriented state, regardless of the detection result obtained by the detection sensor.

5. An image forming apparatus comprising:
the information processing apparatus according to claim 1; and
an image forming device that forms an image on a recording medium.
